(19) United States
(12) Patent Application Publication
(10) Pub. No.: US 2012/0007442 A1
(43) Pub. Date: Jan. 12, 2012

(54) Rotary data and power transfer system

(76) Inventors: Mark Rhodes, West Lothian (GB); Brendan Hyland, Edinburgh (GB)

(21) Appl. No.: 13/228,595

(22) Filed: Sep. 9, 2011

Related U.S. Application Data
(63) Continuation-in-part of application No. 12/366,856, filed on Feb. 6, 2009.

(51) Int. Cl. H02J 17/00

(52) U.S. Cl. 307/104

(57) ABSTRACT

A data and power transfer system comprising a first system unit which includes a first communication element operable to transfer communication signals and a first connector element operable to transfer electrical power; and a second system unit which includes a second communication element operable to transfer communication signals and a second connector element operable to transfer electrical power, wherein the first communication element and second communication element are operable to transfer data between one another and the first connector element and second connector element are operable to transfer electrical power whilst electrically insulated from one another.

### CROSS-REFERENCE TO RELATED APPLICATIONS

This application is a continuation-in-part of U.S. Ser. No. 12/366,856, which application is fully incorporated herein by reference.

### FIELD OF THE INVENTION

The present invention relates to a connector system providing transfer of electrical power and data communications signals between two systems. The connector has no conductive electrical connection and can operate independently of angular orientation.

### BACKGROUND OF THE INVENTION

Electrical connections are a challenging aspect of underwater electrical system design, electrical conductive contact being the most common method of implementing an electrical mateable connector. Electrically conductive contact connectors are commonly subject to corrosion and contamination, which can result in a resistive contact point and failure of the connector function. In under water applications water must be excluded from the conductive contacts to prevent short circuits due to the partially conductive nature of water. Wet mating connections are even more challenging since water must be expelled from the conductive contacts during mating and care must be taken to ensure the signal is not applied to the connector while the contacts are exposed to the water before the connection is made to avoid rapid electrolytic corrosion. Connectors that do not rely upon direct conductive contact avoid these issues.

Additionally, any multi-pin connector must be rotationally aligned to ensure registration of the intended cross connections. This requirement can be problematic, particularly in applications where the connection point is not readily accessible by an operator such as connection by an autonomous system deep in the ocean. Slip ring connectors have been designed to avoid this issue but typically employ conductive brush contacts which are subject to corrosion and contamination issues, suffer continuous mechanical wear in rotating applications and present the challenging requirement of an underwater sealed rotating mechanical joint to exclude water from the brush contacts. An electrically insulated data and power connection which mates independent of angular alignment would be beneficial in many underwater applications.

Slip rings may be located at the axis of rotation or with an open bore positioning the ring coupling mechanism set out a radial distance from the axis of rotation. This second class of slip ring is defined as “off axis”.

Various underwater communication systems are known. One of the most common is based on acoustic techniques. A problem with such systems is that they are degraded by noise and interference from a number of sources. They are also subject to multi-path effects and in some environments are virtually unusable. Other underwater communication systems use radio links, e.g. extreme low frequency electromagnetic signals, usually for long-range communications between a surface station and a submerged vessel. These systems typically operate in the far field using physically large electric field coupled antennas and support data rates up to a few bits per second.

WO01/95529 describes an underwater communications system that uses electromagnetic signal transmission. This system has a transmitter and a receiver, each having a metallic, magnetic coupled aerial surrounded by a waterproof electrically insulating material. Use of electrically insulated magnetic coupled antennas in the system of WO01/95529 provides various advantages. This is because magnetically coupled antennas launch a predominantly magnetic field. A similar arrangement is described in GB2163029. Whilst the communications systems of WO01/95529 and GB2163029 have some technical advantages over more conventional acoustic or radio link systems, the functionality described is limited, and for many practical applications the available bandwidth is highly restrictive, as is distance over which data can be transmitted.

Magnetic antennas formed by a wire loop, coil or similar arrangements create both magnetic and electromagnetic fields. The magnetic or magneto-inductive field is generally considered to comprise two components of different magnitude that, along. with other factors, attenuate with distance (r), at rates proportional to 1/r² and 1/r³ respectively. Together they are often termed the near field components. The electromagnetic field has a still different magnitude and, along with other factors, attenuates with distance at a rate proportional to 1/r. It is often termed the far field or propagating component.

Signals based on electrical and magnetic fields are rapidly attenuated in water due to its partially electrically conductive nature. Seawater is more conductive than fresh water and produces higher attenuation. Propagating radio or electromagnetic waves are a result of an interaction between the electric and magnetic fields. The high conductivity of seawater attenuates the electric field. Water has a magnetic permeability close to that of free space so that a purely magnetic field is relatively unaffected by this medium. However, for propagating electromagnetic waves the energy is continually cycling between magnetic and electric field and this results in attenuation of propagating waves due to conduction losses.

The attenuation losses, the bandwidth restrictions and the limited distances over which data can be transmitted all pose significant practical problems for underwater communications.

Existing methods of acoustic communication are inherently restricted in the distance they can achieve at effective data rates. This is particularly true where the signal reaches a receiver by multiple paths (reflections occurring from an irregular sea floor, the sea surface, the coastline, nearby objects and the like, we well as when the sound wave path exhibits discontinuities in its properties (wave wash, bubbles in the water, changes in water density due to salinity variations). Little is known which can lessen these difficulties. The existing art of electromagnetic communication under water fails to recognize measures that can be taken to maximize the distance and/or useful information rate which can be achieved by adapting the devices sourcing and using the information so that more effective signal frequencies can be adopted.

There is a need for an integrated system that is capable of transmitting electrical power and data across a rotating interface under water.

### SUMMARY OF THE INVENTION

According to an aspect of the present invention there is provided a data and power transfer system comprising a first system unit which includes a first communication element operable to transfer communication signals and a first connector element operable to transfer electrical power and a second system unit which includes a second communication element operable to transfer communication signals and a second connector element operable to transfer electrical power wherein the first communication element and second communication element are operable to transfer data between one another and the first connector element and second connector element are operable to transfer electrical power between one another whilst electrically insulated from one another.

The data and power transfer system being operable to transmit data and power between the first system unit and second system unit without the need for direct electrically conductive contact means, so that in essence they are electrically insulated from one another, that in environments or uses where implementing a direct electrical contact between two system units could compromise either of the units, data and power transfer is possible which maintaining the integrity of each system unit. By separating the power transfer from data communications functions of the system each of the functions can operate more effectively.

Preferably, the data and power transfer system comprises a first system unit and a second system unit arranged to form an off axis connector arrangement. In an off axis connector arrangement the connector elements are aligned about a common axis.

The first connector element and the second connector element may be rotatable relative to one another.

The data and power transfer system may further comprise an actuating system, connected to one of said first and second system units, wherein the actuating mechanism is operable to interface with the connector element and communication element of the system unit.

The actuating mechanism may further comprise a controller unit operable to receive data from the interfaced connector unit and a tool unit, such that the controller is operable to control the tool unit in response to data received.

The tool unit may be a cutting tool.

There may further be provided a tool system comprising a data and power transfer system which includes a first system unit which includes a first communication element operable to transfer communication signals and a first connector element operable to transfer electrical power and a second system unit which includes a second communication element operable to transfer communication signals and a second connector element operable to transfer electrical power wherein the first communication element and second communication element are operable to transfer data between one another and the first connector element and second connector element are operable to transfer electrical power between one another whilst electrically insulated from one another and a tool unit whereby the tool unit is interfaced with one of said first system unit and second system unit.

As the connector elements are electrically insulated from one another and therefore transmit power without the need for direct electrically conductive contact, they are suitable for use in environments where direct electrically conductive contact could be detrimental to the system.

Preferably, the data and power transfer system comprises a first system unit and a second system unit arranged to form an off axis connector arrangement. In an off axis connector arrangement the connector elements are aligned about a common axis.

The first connector element and the second connector element may be rotatable relative to one another.

The tool system may be a rotary tool system.

The data and power transfer system may be a rotary data and power transfer system.

The present invention relates to an off axis connector system for the transfer of electronic signals and electrical power between two units without the need for direct electrically conductive contact and independent of connector rotation about the mating axis. Signals are communicated by employing electro-magnetic coupling to remove the need for direct electrical conductive contact.

An off-axis rotary transformer design suitable for use in the system of the present invention is disclosed in our co-pending application US2010/0102915 “Electrical Connector System” the contents of which are incorporated here by reference.

A through water radio data communications system suitable for use in the system of the present invention is disclosed in U.S. Pat. No. 7,711,322B2 “Underwater Communications System” the contents of which are incorporated here by reference.

Data transfer is possible over a greater separation distance than power transfer since a greater loss can be tolerated between the transmitter and receiver transducers as part of a communication link budget than in power transfer.

Power transfer is achieved through a closely coupled transformer structure at the interface between the primary and secondary halves of the system which may rotate relative to one another.

The through water radio communication system may be located either side of the power coupling structure since data communications can be accomplished over a greater coupling distance than electrical power transfer.

This arrangement separates power transfer from data communications functions allowing each to be designed more efficiently as components of a combined system.

A combined rotary data and power transfer system may be used to power, monitor and control equipment on the secondary side of the system which may rotate relative to the primary.

Power and data link provision to rotating electrical equipment is a common requirement. By integrating the delivery of electrical power and wireless data transmission in a single system a variety of tasks can be efficiently accomplished.

In one example embodiment the primary side of the data and power system is fixed to a subsea pipe structure. The secondary side interfaces to a rotary cutting mechanism. Blades are used to cut through a steel pipe which passes through the center of the present rotary data and power transfer system. The purpose of this arrangement is to cut through the lower section of pipe. Electrical power is supplied to the secondary side to power the cutting blades. The cutting blades are equipped with a sensor system which monitors the cutting resistance and this data is transmitted back across the rotating interface by the integrated through water communications system. A control system then varies the cutting speed in response to this measured cutting resistance by transmitting cutting motor control data back across the rotating interface. The cutting system described here is enabled by the rotary data and power transmission system of the present invention.

Other rotary systems which may incorporate the disclosed rotary data and power transfer system include, but are not limited to; rotary propulsion systems; rotary welding systems; pipe deployment systems; pipe inspection systems; rotary machines; pumps.

By employing lower frequency radio signaling techniques the system may effectively communicate through the material of the seabed. The rotary cutting system may descend into the seabed to effect a cut below the surface.

Preferably, the connector employs a circular coil structure surrounded by a flux guiding enclosure that inductively couples energy from a primary winding to a secondary coil arranged at an equal radial distance displaced along the axis of symmetry. The flux guiding enclosure is elongated in the radial plane to reduce the magnetic reluctance of the gap, which is present at the mating surface.

Multiple independent channels may be implemented by arranging multiple coupling coils at different radial distances in a common plane centered round a common axis. The design can support multiple independent power or data channels independent of connector rotation about the axis of symmetry.

The electrically insulated nature of the connector assembly lends itself to underwater applications or situations where there is a high probability of liquid contaminants. The connector provides a highly reliable underwater connector function without the limitations imposed by the need to keep a conductive contact dry. The connector can also be “wet mated” entirely submerged under water without the need to devise a complex mechanical assembly to expel water from the contact area.

Coupling efficiency is improved by minimizing the gap between flux guiding enclosures at the mating surface. This connector design has two distinct classes of application. Firstly as a static connection that can be mated independent of angular orientation so simplifying automated connector mating. Here the mating faces are not required to rotate significantly once the connection has been made so the gap between faces can be minimized by using metal to metal contact or physical contact of protective painted surfaces. A second class of application is as a rotating connector and in this case, mechanical measures must be taken to reduce friction between rotor and stator at the mating surface. In this case a plastic sheet will be attached to the mating surface of each connector half-preferably constructed from an oil impregnated nylon material or alternative material exhibiting low sliding kinetic friction.

There may further be provided an electrical connector comprising a circular primary coil winding magnetically coupled to a secondary circular coil in a connected mating half through a magnetic flux guiding structure that is elongated either side of the coil in the plane of the coil to form flux coupling wings. The connector structure is rotationally symmetric with an unoccupied area about the center of symmetry. Connector mating is independent of angular orientation about the connector's axis of symmetry

The primary and secondary coils are substantially aligned about a common axis of rotational symmetry and the cross sectional width of the rotationally symmetric connector structure is less than the inner radius dimension.

The flux guiding structure is constructed from a material having a relative permeability greater than 10 and comprises flux coupling wings either side of a central coil enclosure. It is composed of at least two sections divided by a linking electrically insulated material. Wing length is greater than 2 times the flux guide material thickness and less than 50 times the gap dimension separating the primary flux guide from the secondary flux guide at the mating surface. A material with low coefficient of sliding kinetic friction is located between the mating surfaces to facilitate relative rotation of the connector halves.

Multiple independent connection channels are implemented by separate concentric primary coils coupled to corresponding secondary coils

The connector components allow mating to any other connector component.

The volume enclosed by the flux guiding structure is filled with electrically insulating material in at least one position along its circumference or continuously filled with insulating material to prevent a shorted loop resulting from the enclosed partially conductive water.

An optical communications connector or conductive slip ring connector may be positioned at the center of rotational symmetry to provide additional independent functionality.

The communications element of the system will now be described in detail.

Accordingly, an object of the present invention is to provide an improved underwater communication systems, and its methods of use, that uses electromagnetic waves for communication and propagation.

Another object of the present invention an underwater communication system, and its methods of use, for communication and propagation that increases the distance over which information can be transmitted.

Another object of the present invention an underwater communication systems, and its methods of use, for communication and propagation that increases the useful information rate.

Another object of the present invention an underwater communication systems, and its methods of use, for communication and propagation with improved data compression by reducing the transmitted bit rate.

Another object of the present invention an underwater communication systems, and its methods of use, for communication and propagation where the transmitted bit rate is reduced when there are a number of types of information sources.

Another object of the present invention an underwater communication systems, and its methods of use, for communication and propagation that has a resultant reduced bit rate that allows lower transmitted signal frequencies to be adopted.

Another object of the present invention an underwater communication system, and its methods of use, for communication and propagation that has lower transmitted signal frequencies to achieve greater distance and/or allow greater rates at a particular distance.

These and other objects of the present invention are achieved in, an underwater communications system for transmitting electromagnetic and/or magnetic signals to a remote receiver that includes a data input. A digital data compressor compresses data to be transmitted. A modulator modulates compressed data onto a carrier signal. An electrically insulated, magnetic coupled antenna transmits the compressed, modulated signals.

In another embodiment of the present invention, an underwater communications system includes a receiver that has an electrically insulated, magnetic coupled antenna for receiving a compressed, modulated signal. A demodulator is provided for demodulating the signal to reveal compressed data. A de-compressor de-compresses the data.

In another embodiment of the present invention, an underwater communications system includes a transmitter for transmitting electromagnetic and/or magnetic signals. A receiver receives signals from the transmitter. At least one intermediate transceiver receives electromagnetic and/or magnetic signals from the transmitter and passes them to the receiver. At least one of the transmitter and receiver is underwater and includes an electrically insulated, magnetic coupled antenna.

### BRIEF DESCRIPTION OF THE DRAWINGS

Various aspects of the invention will now be described by way of example only and with reference to the accompanying drawings, of which:

FIG. 1A shows an embodiment of a through water communications element suitable for use in a rotary data and power transfer system of the present invention;

FIG. 1B shows an alternatively embodiment of a through water communications element suitable for use in a rotary data and power transfer system of the present invention;

FIG. 1C shows a rotary transformer element suitable for use in a rotary data and power transfer system of the present invention;

FIG. 1D shows an embodiment of a rotary data and power transfer system;

FIG. 1E shows an embodiment of a rotary pipe cutting system;

FIG. 1F shows a block diagram of a rotary pipe cutting system;

FIG. 1G shows another embodiment of a rotary pipe cutting system;

FIG. 2 shows a single channel connector element mating face;

FIG. 3 shows a cross sectional view through a pair of rotationally symmetrical mated connector elements;

FIG. 4 shows a two channel connector element mating face;

FIG. 5 shows a plan view and corresponding cross sectional view of a connector element installed around a pipe section;

FIG. 6 shows a plan view and corresponding cross section view of a single section of a first embodiment of a flux guiding enclosure;

FIG. 7 shows a plan view and corresponding cross section view of a single section of a second embodiment of a flux guiding enclosure;

FIG. 8A shows a connector element mounted on a conical guiding pin;

FIG. 8B shows a connector element mounted on guiding pin provided on a submersible vehicle where a guiding pin forms part of the vehicle's nose section;

FIG. 9 shows dimensions relevant to one embodiment of flux guide design;

FIG. 10 shows a schematic diagram of one embodiment of a rotary data and power transfer system in use;

FIG. 11 shows a schematic diagram of another embodiment of a rotary data and power transfer system in use;

FIG. 12 shows an axial rotary connector positioned at the center of a connector element;

FIG. 13 shows a plan view and a corresponding cross section view of an embodiment of pair of corresponding connector elements; and

FIG. 14 is a block diagram of one embodiment of an underwater transceiver suitable for use in the system of the present invention.

### DETAILED DESCRIPTION OF THE PREFERRED EMBODIMENTS

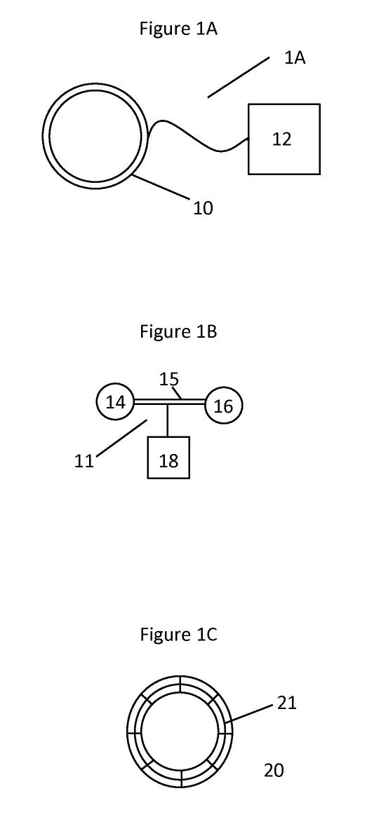

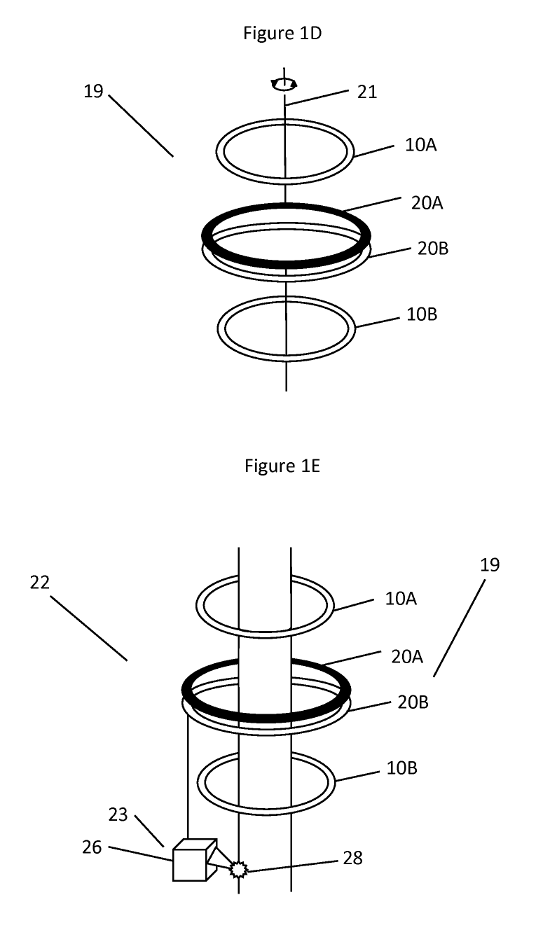

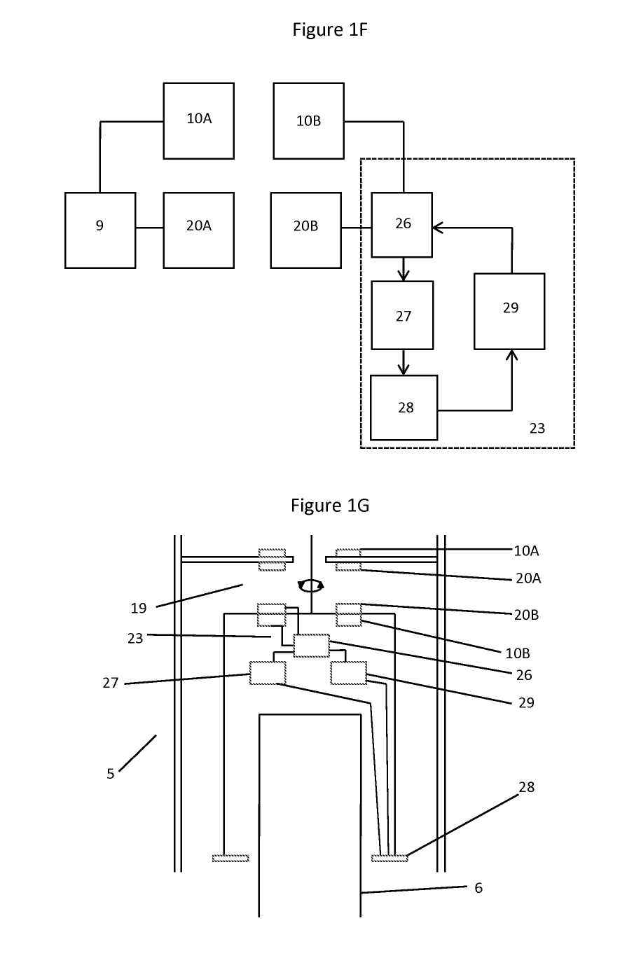

In FIG. 1A there is shown an example embodiment of a through water communications element 1A which is in this case has a radio transmission component which in this case is a loop antenna 10 which combines transmit and receive loop antenna windings in a single overall outer jacket. As can be seen, antenna 10 interfaces to radio modem unit 12. In FIG. 1B there is shown an alternative example embodiment of the through water radio communications element 1B which comprises electrodes 14 and 16 connected by cable 3 to form an electric dipole antenna 11 which interfaces with radio modem 18. In FIG. 1C there is shown a rotary transformer element 20 which, in use, interfaces with a similar transformer (not shown) to couple electrical power without conductive contact.

FIG. 1D illustrates a relative positioning of components arranged for use as one embodiment of an off axis rotary and power transfer system of the present invention. As can be seen, radio modem transducer loop 10A is arranged adjacent primary transfer element 20A which, in use, is arranged adjacent second transformer element 20B which is in turn adjacent radio modem transducer loop 10B.

In use, radio modem transducer loop 10A communicates data, as indicated by arrow 22, with radio modem transducer loop 10B. Primary transformer element 20A couples electrical power to closely coupled secondary transformer element 10B. As is shown in this example embodiment, these components are deployed substantially about a common axis 21 and the secondary elements 10B and 20B are free to rotate relative to the primary components 10A and 20A. Loop antennas 10A and 10B will typically interface with radio modem units (not shown) in a manner similar to the arrangement illustrated in FIG. 1A. Transformer elements 20A and 20B will interface with power transmission and conditioning units as described later in this application.

FIG. 1E shows a rotary pipe cutting system 22 according to an embodiment of the present invention. As can be seen, pipe 24 passes through the center of the “off-axis” rotary data and power transfer system 19. Primary loop antenna 10A communicates data with secondary loop antenna 10B. Primary transformer element 20A transfers electrical power to secondary transformer element 20B. The rotary pipe cutting system unit 23 is provided with a secondary controller 26 which is electrically connected to secondary transformer element 20B. Secondary controller 26 controls the cutting motor (not shown) speed which causes cutting blade 28 to rotate and cut. Secondary controller 26 also monitors the cutting resistance encountered by cutting blade 28.

FIG. 1F shows a block diagram of the rotary cutting system 22 of FIG. 1E. In use, primary controller 8 issues a cut start command through primary radio data modem 10A to secondary radio data modem 10B which passes on the command to secondary controller 26. Primary controller 8 also receives data from radio modem 10A and passes control information to radio modem 10A. Primary controller 8 also controls primary power transfer element 20A. Primary transformer element 20A transfers electrical power to secondary transformer element 20B. Secondary controller 26 controls the speed of cutting motor 27 which causes cutting blade 28 to rotate and cut. Secondary controller 26 also monitors, by means of cutting resistance monitor sensor 29, the cutting resistance encountered by cutting blade. Secondary controller 26 relays data from cutting resistance monitor 29 through radio modem 10B via radio modem 10A to primary controller 8.

FIG. 1G shows a cross section of a second embodiment of rotary pipe cutting system. As can be seen, pipe 6 is inserted into one end of the center of the “off-axis” rotary data and power transfer system 19. Primary loop antenna 10A, which is supported on cutting system support 5, communicates data with secondary loop antenna 10B. Primary transformer element 20A transfers electrical power to secondary transformer element 20B. The rotary pipe cutting system unit 23 is provided with a secondary controller 26 which is electrically connected to secondary transformer element 20B. Secondary controller 26 controls the cutting motor 27 speed which causes cutting blade 28 to rotate and cut. Secondary controller 26 also, though cutting resistance monitor 29, monitors the cutting resistance encountered by cutting blade 28.

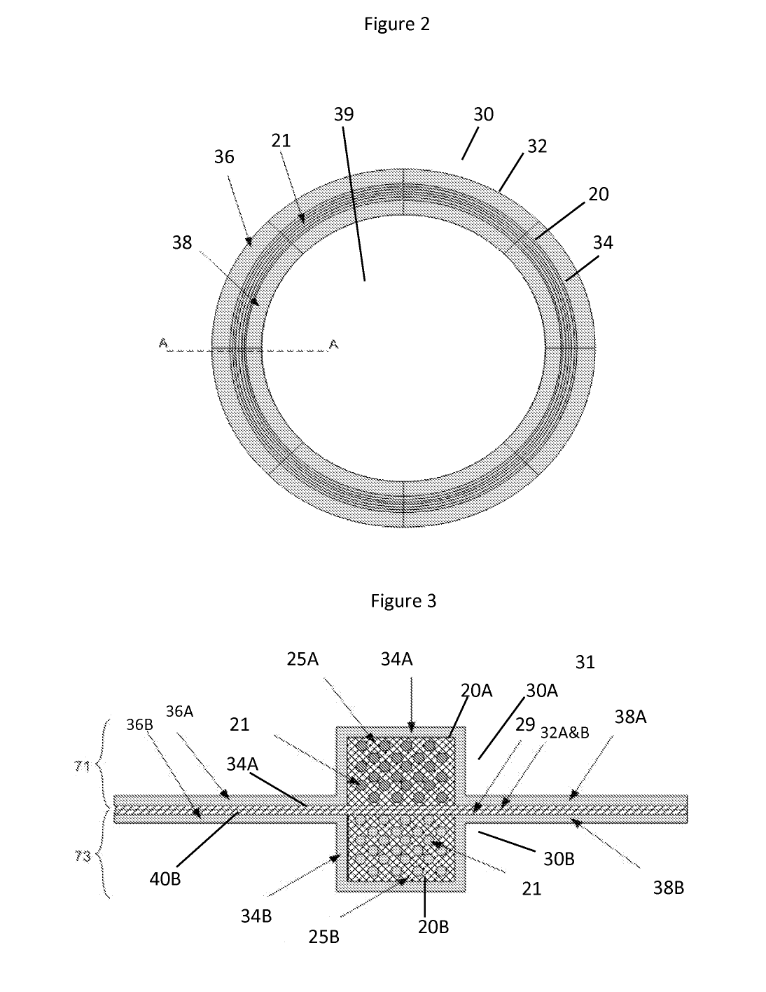

FIG. 2 shows the mating face 32 of a single channel connector part 30. Multiple circular turns form the primary coil 11 of a transformer system element 11A. A ferrous metal flux guiding structure 34 encloses the coil 11 and is extended to form coupling “wings” 36 and 38. The central region 39 of the single channel connector 30 structure is open and is available to enclose other structures, for example local mechanical structures (not shown), without significantly affecting connector 30 performance. This class of slip ring connector is often termed “off-axis”. Section A-A is represented in detail in FIG. 11B. Typically, the cross sectional width x of the rotationally symmetric connector structure through section A-A, is less than the inner radius dimension r.

FIG. 11B shows a cross sectional view through part of a rotationally symmetrical mated connector 34A shown as section A-A in FIG. 2 that has a first half 71, wherein the connector part 30A is of the form shown in FIG. 2, that has a multiple turn primary coil 11A and a second half 73, where the connector part 30B is of similar shape and construction to connector part 30A in which is located a multiple turn secondary coil 11B. The cross section is symmetrical about a horizontal plane h and this plane of symmetry represents the mating surface 32 between the two-connector parts or “halves” 30A, 30B. Both halves 30A, 30B are mechanically similar, which allows the possibility of mating any suitable connector to any other without the limitations imposed by a more typical keyed conductive connector (not shown). This degree of connection flexibility is commonly referred to as a “hermaphrodite” connector.

Enclosing the primary coil 11A is a first flux guiding structure 34A and enclosing the secondary coil 11B is a similarly shaped second flux guiding structure 34B. Each guiding structure 34A, 34B is elongated parallel to the mating surface to form wings 36A, 36B, 38A and 38B. Wing structures 36A, 36B, 38A and 38B increase the surface area of the mating face 32A, 32B of coupling region 39 so reducing the magnetic reluctance of the gap at the interface between the first and second connector halves 30A, 30B. The effective relative permeability of the whole magnetic circuit is determined almost entirely by the gap distance and relatively little by the relative permeability of the core material.

For applications that experience regular rotational movement between the connector halves 30A and 30B, bearing surfaces 40A and 40B are formed from a material with a low coefficient of sliding kinetic friction. The layer of bearing surface material 40 is bonded to the top connector half 30A while layer 40B is bonded to the lower half connector 30B. Nylon impregnated with lubricating oil will be a suitable material for some applications. Layers 40A and 40B ensure a controlled separating distance between the two flux guiding enclosures 34A and 34B and low mechanical resistance to rotational movement. This reduces the torque necessary to maintain rotational movement where desired and improves the deployed operational life of the connector due to reduced mechanical abrasion.

Flux guides, 34B and 34A, of the two, mated connector parts 30A, 30B form a magnetic circuit which couples magnetic flux generated in the primary coil 11A to the secondary coil 11B. The selected magnetic material of the primary and secondary coils 20A and 20B may have a comparatively low value of relative permeability (for example 10) allowing the freedom to select a material with suitable mechanical and chemical properties for this challenging underwater application. Flux guides 34A and 34B may be manufactured from a ferrous metal, for example 316 or 904L marine grade stainless steel.

Regions 25A and 25B represent the area within the flux guiding enclosure 34A and 34B not fully occupied by the material of the transformer coils 11A, 11B. If water were allowed to occupy these regions it would form a shorted turn due to the partially conductive nature of impure water. A current would be induced in opposition to the transformer coils 11A, 11B and this would impact connector efficiency. To avoid this effect, areas 25A and 25B are filled with an insulating material either continually around the connector circumference or at intervals to break the parasitic conductive circuit. For ease of manufacturing these areas can preferably be filled with an insulating epoxy resin material.

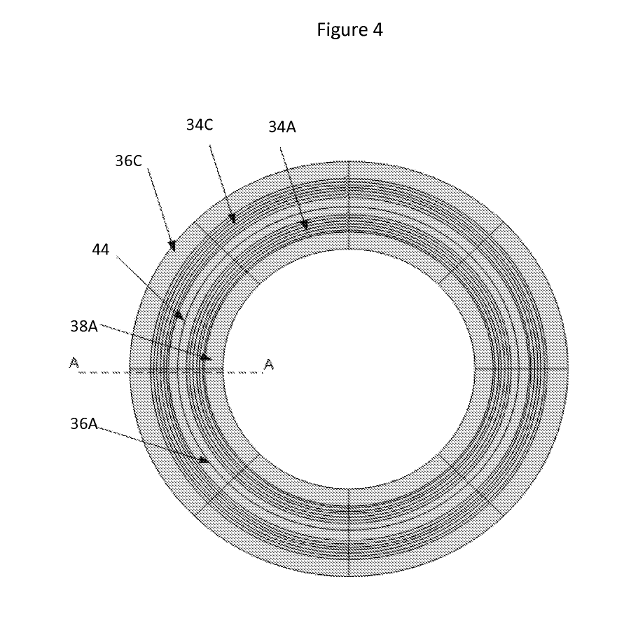

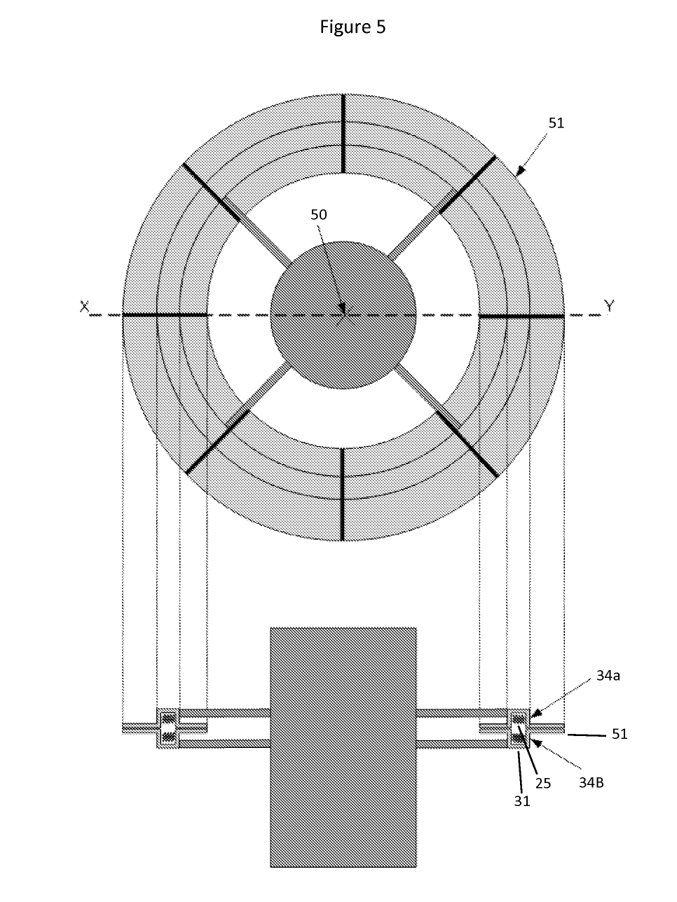

FIG. 4 shows the mating face of a two-channel connector 32C. In this case, two separately wound primary coils 21A and 21C are provided within flux guiding enclosures 34A and 34C. This principle can be extended to implement any number of independent flux guiding enclosures, or channels, 34n by adding additional independent coils 21n at separate radial distances (not shown). Separate channels 34n (not shown) may be used to carry independent communications channels or a mixture of power and data channels. Multiple power channels may be added to increase the power capacity of the connector system. In some implementations a gap (not shown) is introduced at the interface 44 between two adjacent wings 36n and 38n+1 (not shown) to reduce cross coupling between adjacent channels.

FIG. 5 shows a plan view of the connector installed around a pipe section 50 and a corresponding cross sectional view taken through the plane marked X-Y on the plan view. There is shown a static component 51 for mating with the underside of a rotatable component 52. Advantageously, the connector of FIG. 5 can be deployed around an existing structure, as illustrated by the pipe 50. The 50 pipe will have minimal impact on the connector efficiency since the flux guiding enclosures 34A and 34B effectively contains the coupling region 25 within the connector structure 31.

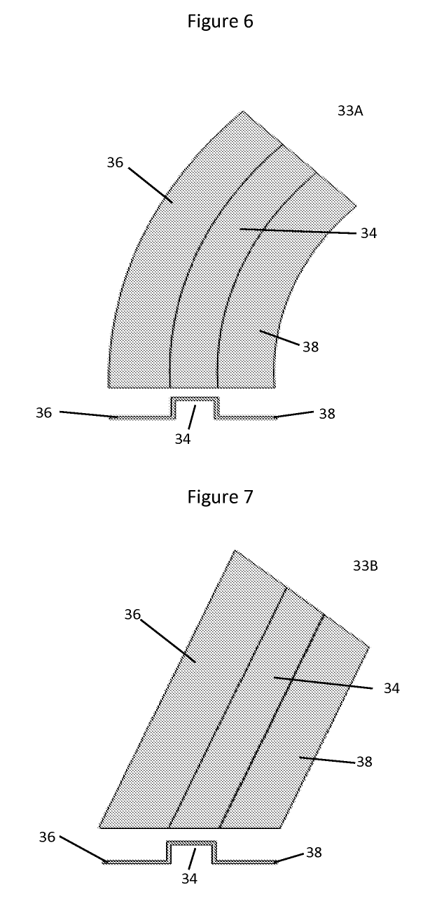

FIG. 6 shows plan view and cross section view for a single section 33A of the flux guiding enclosure 34 of FIGS. 2 and 3. The material chosen for the flux guiding structure 34 may have significant bulk electrical conductivity so the circular structure must be insulated at some point along its radius to prevent a shorted conductive turn, which would reduce connector efficiency. Flux guide sections 34 are connected using an electrically insulating material (not shown) to avoid a shorted turn. FIG. 6 illustrates a 45 degree section 33A but the number of sections selected for a particular installation is a design freedom governed by ease and cost of manufacture.

FIG. 7 shows plan and cross section for a single section 33B of the flux guiding enclosure 34 manufactured from straight section materials. The width of the flux guiding wings 36, 38 introduces, in use, a degree of tolerance to radial misalignment of the primary coils to secondary coils (not shown in FIG. 7). This feature allows the possibility of constructing the circular structure from a number of linear sections with attendant simplification, and hence cost reduction, of the manufacturing process.

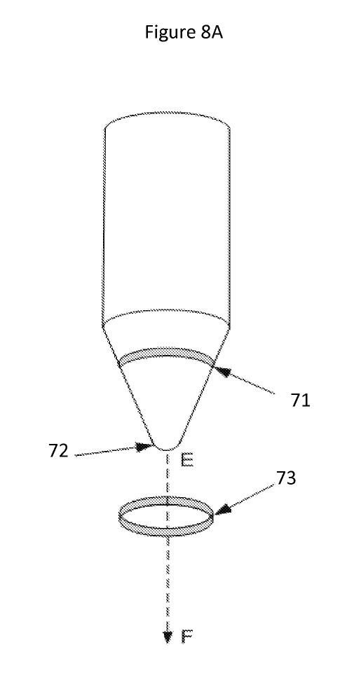

FIG. 8A shows one half of a connector 71 mounted on a conical guiding pin 72 for mating with a coupling ring 73. Using a conical guide 72 reduces the alignment accuracy required for mating. Connector mating can tolerate an initial center misalignment by a distance equal to +/− the coupling ring 73 inner radius since the conical pin section 72 will act to guide the connector part 71 to meet with connector part 73 if given freedom of movement perpendicular to the mating travel direction E-F.

FIG. 8B shows a connector for a submersible vehicle 80. In this case, the first component 71 is mounted on the vehicle's nose section 72, which is shaped conically so as to form a connector guiding structure. The submersible vehicle 80 moves along axis B to C, as indicated in the diagram, to make contact with the second connector 73. Connector mating can tolerate mis-alignment of the vehicle heading by a distance equal to +/− the coupling ring 71, 73 inner radius r since the conical nose section 72 will act to guide the final approach of the vehicle 80. This arrangement is particularly beneficial since the mating axis is aligned with the primary direction of travel of the vehicle 80. The nature of submerged vehicle dynamics ensures the necessary freedom of guided movement in the plane perpendicular to the direction of travel.

Connector coupling is essentially due to a transformer action. Primary and secondary windings may be arranged with a turns ratio desired by the individual application with the resultant relationship between primary and secondary voltage following the usual transformer design principles.

Direct contact of the metallic flux guiding enclosures may be acceptable in applications where little relative rotational movement is experienced. In applications with significant angular rotation direct metallic contact is unlikely to be acceptable due to mechanical abrasion and frictional resistance to movement and in these applications a gap must be devised between flux guides. A non-magnetic material such as PTFE (Poly Tetra Fluoro Ethylene) may be used as a spacer, but the effect is similar to the introduction of an air gap into the core of a magnetic induction device. The size of the gap is critical and is related to most of the key performance measures of the device. Coupling efficiency decreases with increasing gap size and in many applications the spacer layer will several millimeters thick.

The flux guide design features extended “wings” to each side of the winding. These are intended to reduce the reluctance of the magnetic circuit that is much higher than normal in a transformer due to the gap at the mating surface. The larger the wings, the lower the reluctance of the magnetic circuit, minimizing the impact of the gap on performance. However, because most of the flux is concentrated near the windings, there are diminishing returns as the wings are extended.

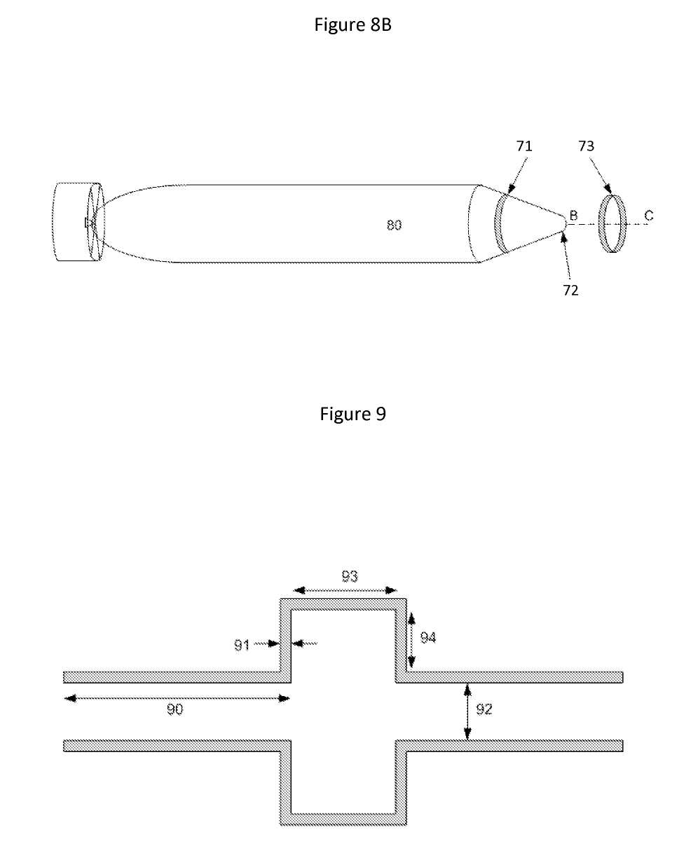

FIG. 9 shows dimensions relevant to flux guide design. The design aim is to reduce the reluctance of the magnetic circuit formed by the primary flux guide, gaps and secondary flux guide. The magnetic reluctance of each of these elements is defined by equation 1. Total reluctance of the magnetic circuit is simply the sum of primary flux guide, inner gap, secondary flux guide and outer gap reluctance.

$$R = \frac{L}{{μ}_{0} {μ}_{r} A} \qquad Equation 1$$

where R=Magnetic reluctance 1/H

L=flux path length

A=flux path cross sectional area m²

μ₀=free space permeability N/A²

μᵣ=material relative permeability

Without the proposed wing structure, the total magnetic reluctance is dominated by the gap since relative permeability is close to unity while the ferrous core material of the flux guide may have a relative permeability of over 1000. By including the wing structure the cross sectional area of the air gap, or plastic spacer, can be increased by many times hence lowering the reluctance of this circuit element. The gap path length can also be minimized and the small gap length to area ratio can compensate for the low permeability of this section. Wing length 90 will beneficially be greater than twice the guide material thickness 91 and typically sees little benefit from further extension once the gap reluctance is small compared to the flux guide reluctance.

The magnetic circuit formed by the flux guide enclosures must provide enough space to accommodate the primary winding that provides the magneto-motive force in the system. The secondary flux guide must also accommodate a secondary winding of similar or slightly larger size. The winding cavity must also provide space for insulating material and protective encapsulation for safe and reliable operation at the required voltage and temperature in a conductive seawater environment. The flux guide design dimensions are represented by; 93 the horizontal covering section; 94 the side wall height; 91 the flux guide thickness; 90 the wing width.

The number of turns in the windings is partly determined by the need to control the magnetizing current and more turns are needed in this case because of the high reluctance in the magnetic circuit due to the gap. The copper loss under no-load conditions will be high as a result and a large winding aperture is required to accommodate large cross section wire to reduce electrical resistance. In FIG. 9, dimensions 93 and 94 should be minimized to fit closely around the required transformer coil volume.

Transformer core losses due to eddy currents are proportional to core volume and in the present design the flux guide enclosure acts as a transformer core. However, the volume of the core must be sufficient to avoid magnetic saturation. For mild steel, the saturation flux density is about 1.5 Tesla.

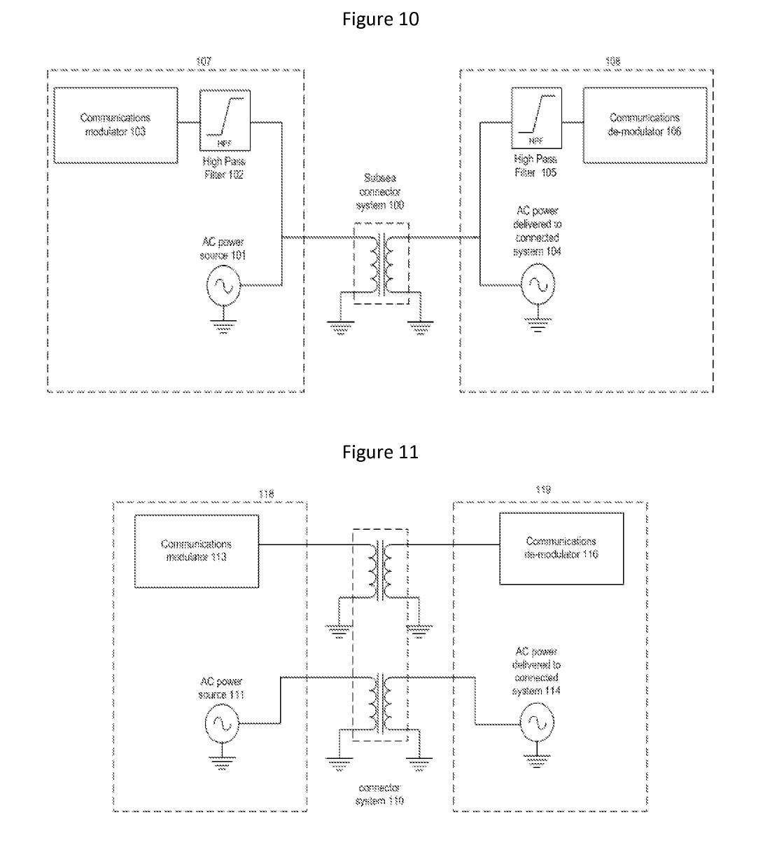

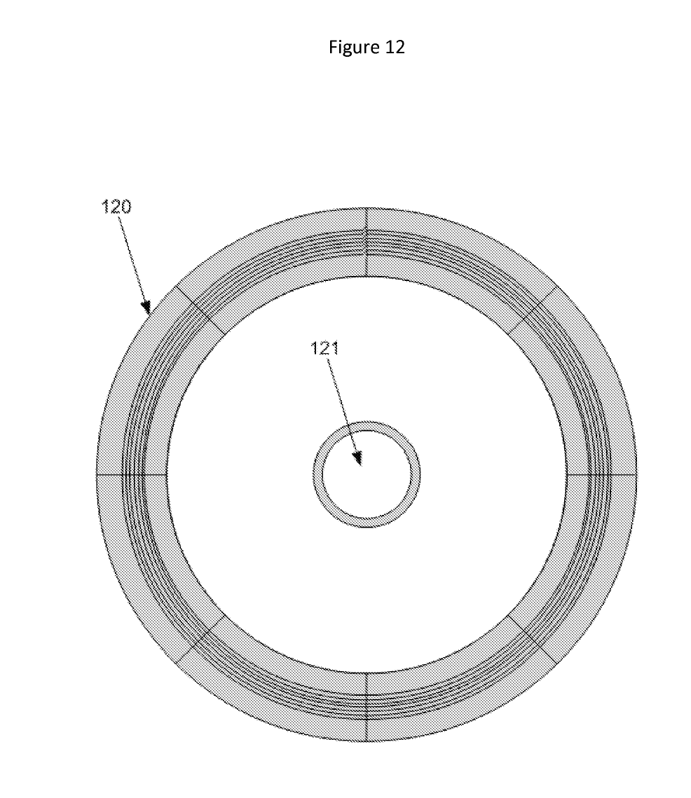

FIG. 10 shows an example application of the connector system that transfers electrical power and data from a source system 107 to a connected system 108. The source system 107 includes a data source 103 and an AC power source 101 the outputs of which are coupled into the primary coil of the connector. The connected system 108 is coupled to the secondary connector coil, so that data and/or power can be magnetically coupled from the source system 107 to the other system 108 via the primary and secondary coils. Coupling efficiency reduces as frequency increases because of leakage inductance effects. Eddy current losses increase with frequency so also act to reduce the bandwidth available for data transmission. Data and power transmission can be separated in frequency to allow simultaneous operation of the two functions. Transfer efficiency is more critical for power transfer than for communications applications so a higher frequency will usually be assigned to the communications signal.

Communications modulator 103 takes a data input and generates an analogue or digital modulated carrier signal. A high pass filter 102 can be used to isolate the modulator 103 from high power AC (Alternating Current) source 101. Subsea connector system 100 couples the AC power signal and communications signal to the connected system 108. The communications signal can be separated from the AC power in the secondary coil by a high pass filter arrangement 105. Data is extracted from the modulated carrier at the communications de-modulator 106. The larger coupled waveform delivers AC power 104 to the connected system.

By way of example an inductive connector system of the type described here with an internal diameter of 1.8 m and external diameter of 2 m is supplied with a 240 V, 4.2 A r.m.s. alternating current, 1 kW power. Primary to secondary coil turns ratio is 1:1 delivering a 240 V r.m.s. supply to the secondary coupled system. An oil impregnated nylon spacer fills the 2 mm gap between the connector halves to provide low friction rotational movement. The primary and secondary coils are constructed from 100 turns of 1211 B6 AWG enameled copper wire occupying a cross sectional area 30 mm wide by 20 mm deep. The flux guide is manufactured from 5 mm thick 316 grade stainless steel.

FIG. 11 shows an alternative arrangement that couples power and data through separate channels in a single multi-channel connector structure. Communications modulator 113 in system 118 takes a data input and generates an analogue or digital modulated carrier signal which is coupled through connector 110 channel A. AC (Alternating Current) source 111 couples through connector 110 channel B to the connected system 119. Data is extracted from the modulated carrier at the communications de-modulator 116. The larger coupled waveform delivers AC power 114 to the connected system.

FIG. 121 shows an on-axis rotary connector 121 positioned at the center of the present connector structure 120. The area around the rotational axis of the present design is not occupied by the present off-axis, open bore connector structure so is available for additional power or data connectors. For example, this connector could be an optical rotary connector as described in CA1166493A1 or a conductive slip ring as described in EP1766761A2 capable of supporting data communications or power transfer.

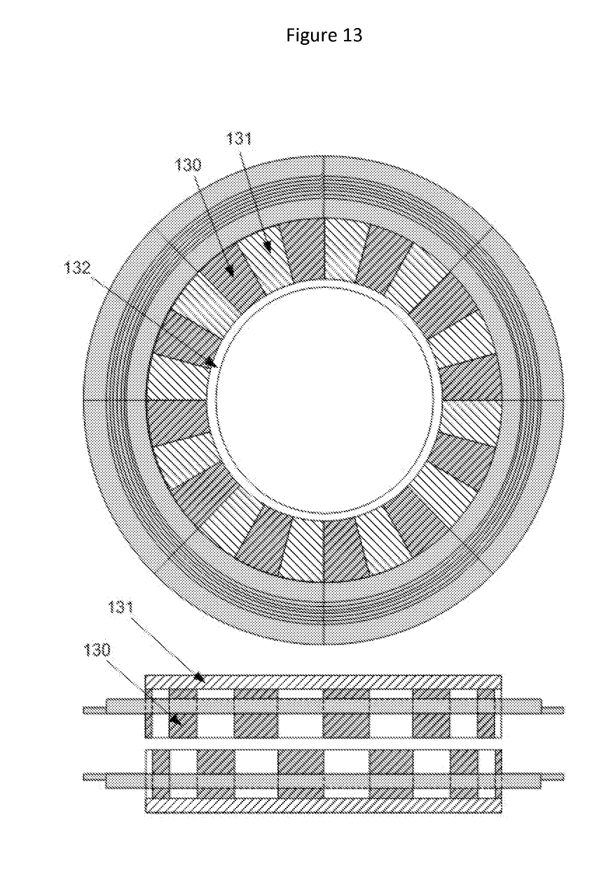

FIG. 13 shows a design for axially registering two mating connectors. The mating parts are annular and mounted in the annulus of the guide structure. Each part has a backing plate 131 that acts as an end stop to movement along the axis of rotation. Mounted on each backing plate 131 are raised crenulations or teeth 130 that interlock one connector component to another so as to prevent rotational movement and axial misalignment. Preferably, the mating parts on each connector part are identical to provide a hermaphrodite connector mating compatibility. To restrict, movement perpendicular to the axis of rotational symmetry, an inner ring structure 132 is provided. This abuts the inner face of the backing plate, without impeding engagement of the crenulations or teeth 130.

No-load losses in this design are large and result from two features; the gap and the solid core. The main contributions to loss are eddy currents in the solid core and primary winding loss due to the magnetizing current. Eddy current loss depends on frequency, flux density, core resistance and core shape. To reduce eddy current loss for a given material and magnetic field it is necessary to make the current path long while making the flux path short and in this design the core material must be as thin as possible, while avoiding core saturation. Winding loss depends on the resistance and inductance of the primary winding. Inductance achieved per unit length of winding is low, due to the presence of the gap, therefore a high magnetizing current flows and power is dissipated in the resistance of the winding. This leads to a selection of a large cross section wire for the primary winding limited by the practical volume, mass and cost of the assembled coil.

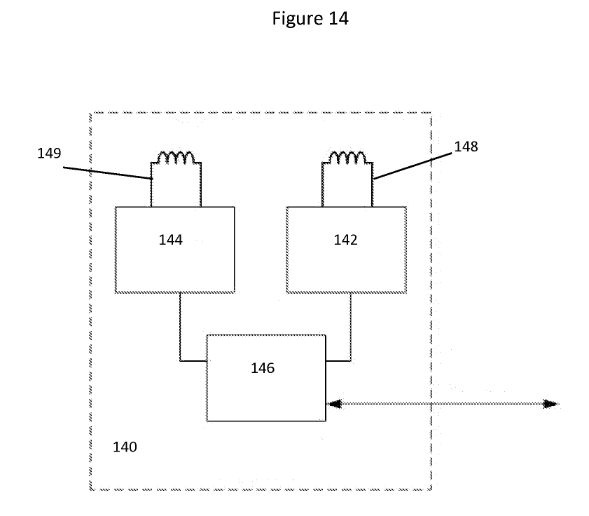

In each of the above embodiments, the communication systems may use a known communications transceiver 140 that has a transmitter 142, a receiver 144 and a processor 146 which can be connected to an analogue or digital data interface (not shown), as illustrated in FIG. 14. Both the transmitter and receiver 142 and 144 respectively have a waterproof, electrically insulated magnetic coupled antenna 148 and 149. Alternatively a single antenna can be shared between transmitter and receiver (not shown). A magnetic coupled antenna is used because water is an electrically conducting medium, and so has a significant impact on the propagation of electromagnetic signals. Ideally, each insulated antenna assembly is surrounded by a low conductivity medium that is impedance matched to the propagation medium, for example distilled water.

Electrically insulated magnetic coupled antennas may be used in the communication systems shown in the embodiments of the present invention because in an underwater environment they are more efficient than electrically coupled antennas. Underwater attenuation is largely due to the effect of conduction on the electric field. Since electrically coupled antennas produce a higher electric field component, in water in the near field, the radiated signal experiences higher attenuation. In comparison a magnetic loop antenna produces strong magneto-inductive field terms in addition to the electromagnetic propagating field. The magneto-inductive terms are greater than the propagating field close to the transmitting antenna and provide an additional means for coupling a signal between two antennas. For both shorter and greater distances, magnetic coupled antennas are more efficient under water than electrically coupled. In applications where long distance transmission is required, the magnetic antenna should preferably be used at lowest achievable signal frequency. This is because signal attenuation in water increases as a function of increasing frequency. Hence, minimizing the carrier frequency where possible allows the transmission distance to be maximized. In practice, the lowest achievable signal frequency will be a function of the desired bit rate and the required distance of transmission.

Any of the above embodiments wherein an underwater communications system is provided for transmitting data to a remote receiver may include a data input; a data compressor for compressing data that is to be transmitted; a modulator for modulating the compressed data onto a carrier signal and an electrically insulated, magnetic coupled antenna for transmitting the compressed, modulated signals. It will be appreciated that the words remote and local used herein are relative terms used merely to differentiate device sites for the purpose of description, and do not necessarily imply any particular distances.

By compressing the data, prior to transmission, the occupied transmission bandwidth can be reduced. This allows use of a lower carrier frequency, which leads to lower attenuation. This in turn allows communication over greater transmission distances, thereby significantly alleviating the difficulty of communication through water. Digital representation of audio and or video, data compression and transmission at the lowest practicable frequency are therefore particularly advantageous in the subsea environment and represents a key innovation. While data compression is usually highly desirable, it will be appreciated that it is not essential to the operation of different embodiments of the present invention.

Whether or not compressed, data in some applications of the present invention can be encrypted before transmission and decrypted after receiving, when desired for reasons of security. Although a low carrier frequency is usually optimal to maximize distance, there may be occasions when a higher frequency is satisfactory but more desirable in order to reduce the distance over which an unwanted receiving party can detect the signal, as in deliberately covert operation of a communication system.

In any of the above embodiments of the present invention, it will understood that error correction techniques may be applied to the information transferred. Error correction techniques slightly increase the amount of data which must pass over the communication links themselves, but can be advantageous in allowing operation at greater distances which otherwise would have resulted in unreliable transfer of information. Error correction can be of the types commonly and generically known as forward error correction (FEC) and automatic repeat request (ARQ). For somewhat random errors which are well spaced and do not occur in long runs, FEC is preferable; and beneficially the effectiveness of FEC may be increased by first applying an interleaving process, as known in the art.

In addition, it will be understood that in any of the above embodiments, an acoustic transmitter and receiver system may be used as the means of providing wireless data communications across the rotating interface.

Alternatively, an optical transmitter and receiver system may be used as the means of providing wireless data communications across the rotating interface.

The communications module of the present invention may include a receiver that has an electrically insulated, magnetic coupled antenna for receiving electromagnetic signals. The module is preferably operable to present received text/data and/or video/images on the module display. The transmitter and the receiver may share a single electrically insulated, magnetic coupled antenna.

It will be understood that the system of the present invention can be configured to change the carrier frequency to optimize the information communication rate for the transmission range and conditions encountered. In another embodiment, the system of the present invention can be configured to establish a connection; commence transmission at a first frequency; once communication is established, vary the frequency and select the frequency based on the received signal strength.

The magnetic coupled antenna used with certain embodiments of the present invention can be based on loops or solenoids. The solenoid may be formed around a high magnetic permeability material.

Near field subsea magneto-inductive communications links can support much higher carrier frequencies than possible in the far field. In turn, communication in the near field allows a significantly higher signal bandwidth than is available for far field transmissions. While the near field components are relatively greatest close to an antenna, their rate of decline with distance is faster than that of the far field component When the antenna is magnetic, the important advantage of lower loss is gained over conventional electromagnetic antennas of the types commonly used in free space. In addition the relative initial strength of the magnetic field in comparison with the electromagnetic field is considerably greater still.

It will be appreciated that in the embodiments of the present invention detailed, the communications element may include an electric dipole arrangement used as a transmit or receive transducer to couple the electrical signal into or out of the water. In transmit, a Voltage is developed between two spaced electrodes in direct conductive contact with the water. In receive an amplifier monitors the potential developed across two spaced electrodes in direct conductive contact with the water.

In the embodiments of the present invention detailed above, at least one of the transmitter and receiver includes means for varying the signal gain. This is advantageous for systems in which one or both antennas may be subjected to wave wash, where the antenna is periodically partially or wholly immersed in water. By providing means for varying the gain, performance can be maintained even when one or more of the antennas is subject to wave wash.

It will be further understood that communications system elements of the above embodiments may include a device for transmitting electromagnetic signals and means for transmitting acoustic signals and/or optical signals. In use, the system of this embodiment can be controlled such that the optimal route for communication is utilized be it electromagnetic, acoustic or optical. Under different or changing conditions, one or more of these methods may provide superior performance at different times.

For reception of weak signals, such as at greater distances, the reduction of received interfering noise will be important. This may be accomplished in the system of the present invention by filtering the received signal to the minimum bandwidth possible, consistent with the bandwidth of the wanted signal, before making decisions on the received digital signal states. Alternatively, or in addition, digital bit states may be represented in transmission by known and readily distinguishable sequences of sub-bits transmitted at a higher rate, and correlation techniques adopted to determine the likely presence of each sequence and hence the value of each received bit. Such techniques will be familiar to those skilled in the techniques of communication in other fields.

A further technique, often advantageous where effects such as multi-path propagation, fading and dispersion exist between transmitter and receiver, is that of spread spectrum, in which transmission power is deliberately distributed over a wide bandwidth and correlation methods are used in receivers. As will be known to communication practitioners, the spread spectrum technique is enhanced if the known RAKE method is also adopted in receivers.

Furthermore, while carrier-based techniques with impressed modulation have been described, un-modulated methods without a carrier also may be adopted, wherein a representation of the baseband data is used directly to energize the antenna.

In all of the above detailed embodiments of communications elements of the present invention, the operating signal carrier frequency will depend on the particular application. The carrier frequency is selected as a function of the data transfer rate and the distance over which transmission has to occur. For example, for short-range communications where a high data rate is required, a relatively high frequency would be used, for example above 1 MHz. In contrast for long-range communications where attenuation losses are likely to be a problem, relatively low frequencies would be used, for example below 1 MHz, and in many cases below 100 kHz.

Another technique that may be applied in any of above detailed embodiments is the use of an adaptive carrier frequency based on range of operation. In this implementation, the carrier frequency employed to convey information is chosen to maximize the information rate possible for the given signal path. The most significant influence on the optimum frequency to choose will be the range between the communicating systems. One implementation uses multiple fixed frequencies that are known to all communicating stations. To first establish a connection, transmission commences on the lowest frequency. Once communication is established, the systems may then adapt the frequency of operation up and down to maximize data rate. This may be performed based on the received signal strength. An alternative scheme employs the lowest frequency at all times to maintain timing and to communicate the main frequency being chosen to carry information.

The electromagnetic communication system which may be included in embodiments of the invention as detailed here within, may be combined with acoustic communication and/or with optical communication to provide enhanced capability. Whereas acoustic communications offer long-range capability they are limited in terms of robust operation in noisy environments and can only offer a limited bandwidth. The range of operation is limited with electromagnetic communications but it is immune to acoustic noise and has a wide bandwidth capability. By way of example a system of the present invention can include an acoustic modem and an underwater electromagnetic communications system as described above. The two systems can be combined in a processing unit to select the communications path based on appropriate criteria. These criteria may include factors such as measured error rates, range of operation, measured signal strength or required bandwidth. If very high bandwidth is required when the ends of the communication link are close enough to allow optical communication, this method similarly may be brought into operation in preference to, or in addition to, electromagnetic communication.

Directional antennas may be adopted to concentrate and maximize the power which a transmitter sends in the direction of a receiver and, by the principle of reciprocity, which a directional receive antenna can intercept. In as much as directional properties can be improved, communication range will be increased. If transmit and/or receive antennas are steered towards each other, preferably with dynamic real-time adjustment, then the optimum signal can be provided at all times. Diversity techniques employing multiple antennas at receive and/or transmit sites may be adopted, and intelligent switching adopted to use the most advantageous signal path at any time.

The magnetic and electromagnetic field from a transmitter (and correspondingly a receiver) may be increased by using latest magnetic core materials of the highest possible permeability in the antenna in order to increase magnetic flux for given antenna dimensions.

While magnetic coupled antennas may be used, electromagnetic antennas of plain wire similar to those of conventional radio methods, and electric antennas which predominantly excite and detect an electric field, can also be deployed; and they may be deployed in combination to achieve the strongest aggregate received signal.

Those familiar with transformer and communications techniques will understand that the foregoing is but one possible example of the principle according to this invention. In particular, to achieve some or most of the advantages of this invention, practical implementations may not necessarily be exactly as exemplified and can include variations within the scope of the invention. For example, a similar system description could apply where a higher permeability ferrite material is selected for the flux guiding enclosure other than that specified in the foregoing examples. It will be further understood that whilst the embodiments of the present invention are described with reference to the rotary data and power transfer system arranged to operate a rotary cutting mechanism, the system may operate any actuating means required including, but not limited to, a camera system, measuring system, sensor system, pump system or welding system.

1. A data and power transfer system comprising:
a first system unit which includes a first communication element operable to transfer communication signals and a first connector element operable to transfer electrical power; and
a second system unit which includes a second communication element operable to transfer communication signals and a second connector element operable to transfer electrical power,
wherein the first communication element and second communication element are operable to transfer data between one another and the first connector element and second connector element are operable to transfer electrical power whilst electrically insulated from one another.

2. A data and power transfer system as claimed in claim 1 wherein the first system unit and a second system unit are arranged to form an off axis connector arrangement.

3. A data power transfer system as claimed in claim 1 wherein the first connector element and the second connector element are rotatable relative to one another.

4. A data and power transfer system as claimed in claim 1 further comprising an actuating system, connected to one of said first and second system units, wherein the actuating mechanism is operable to interface with the connector element and communication element of the system unit.

5. A data and power transfer system as claimed in claim 4 wherein the actuating mechanism further comprises a controller unit operable to receive data from the interfaced connector unit; and a tool unit, such that the controller is operable to control the tool unit in response to data received.

6. A data and power transfer system as claimed in claim 5 wherein the tool unit is a cutting tool.

7. A tool system comprising:
a data and power transfer system which includes a first system unit which includes a first communication element operable to transfer communication signals and a first connector element operable to transfer electrical power and a second system unit which includes a second communication element operable to transfer communication signals and a second connector element operable to transfer electrical power wherein the first communication element and second communication element are operable to transfer data between one another and the first connector element and second connector element are operable to transfer electrical power whilst electrically insulated from one another; and
a tool unit,
whereby the tool unit is interfaced with one of said first system unit and second system unit.

8. A tool system as claimed in claim 7 wherein the data and power transfer system comprises a first system unit and a second system unit arranged to form an off axis connector arrangement.

9. A tool system as claimed in claim 7 wherein the first connector element and the second connector element may be rotatable relative to one another.

10. A tool system as claimed in claim 7 wherein the tool system is a rotary tool system.

11. A tool system as claimed in claim 7 wherein the data and power transfer system is a rotary data and power transfer system.
